(19) United States
(12) Patent Application Publication
(10) Pub. No.: US 2004/0078282 A1
(43) Pub. Date: Apr. 22, 2004

(54) Electronic sales receipt and report generator

(76) Inventor: Rebecca Robinson, Denver, CO (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 10/277,637

(22) Filed: Oct. 21, 2002

(51) Int. Cl. G06F 17/60

(52) U.S. Cl. 705/26

(57) ABSTRACT

A method and system for generating electronic receipts and reports relating thereto. Transactions occurring at one or more points of purchase are electronically transmitted to and stored in a database as data records. Purchaser information, including a purchaser electronic mail address, is also stored as a data record in the database, as is information relating to the point of purchase. Discrete information from the data records is used to create an electronic receipt, which is transmitted via electronic mail to the purchaser. The purchaser may print the receipt and use it as necessary. Various reports may also be generated by manipulating the data records.

### BACKGROUND OF THE INVENTION

1. Technical Field

The invention relates generally to providing receipts for goods or services purchased by a customer, and more specifically to an electronic mail receipt generator capable of providing electronic receipts for goods or services procured by a purchaser, as well as reports analyzing purchasers' shopping habits.

2. Description of Background Art

Since the beginnings of civilization, people have traded one good for another. With the rise of centralized authority, basic bartering was standardized. Certain commodities arose as the standards against which people would determine the value of other items. For example, Native Americans used a “wampum standard” well into the 18^{th} Century to determine how much one item was worth versus another. As another example, ancient Romans used salt as their medium of exchange, even going so far as to pay soldiers in handfuls of salt.

Of course, trading bags of salt, shells, or cattle can be rather inconvenient. To simply trade, paper money was first circulated in China around 600 A.D. Western Europeans discovered this concept through Marco Polo's explorations of China in the 13th Century. Europe, however, did not adopt paper money for many years. Not until the 1600s did Europeans begin to use a simple form of paper money. During that century, many London merchants would deposit gold in various goldsmiths' storerooms for safekeeping. In return, the goldsmiths would give receipts verifying the deposits. As this practice became more common in England, merchants began to take receipts made out by one smith to another to be cashed. Eventually, people were using the receipts among themselves, trading them for goods and services. Eventually, issuance of receipts for goods and services became common.

Today, while receipts may be used to show debts from one entity owed another (as in an “I.O.U.” or debit note), receipts also serve a different purpose. Most companies and service providers issue receipts to verify the sale of goods or services to a purchaser. Like the English goldsmiths' receipts, modern receipts may be returned for refunds when a purchaser is dissatisfied with the quality of the goods or services.

A modern store may issue hundreds, or even thousands, of receipts a day. Many corporations may issue hundreds of thousands of receipts per day, when all individual stores that make up the corporate chain are considered. Keeping track of such an incredible volume of receipts and associated transactions can be extremely challenging.

Further, a purchaser who goes to multiple stores in a single day may find himself with several receipts. These receipts are typically stuffed in a wallet, pocket, or purse. Rarely does a purchaser keep track of receipts. Many times, receipts are lost when the purchaser cleans his or her wallet or purse. Since most (if not all) stores require a valid receipt for the return or exchange of goods, purchasers are often left with no recourse but to keep goods that they may otherwise wish to return.

### SUMMARY OF THE INVENTION

Generally, the present invention comprises a method and system for creating, storing, transmitting to a customer, and tracking an electronic receipt. The invention further comprises a method and system for manipulating, viewing, and data mining a database containing electronic receipts, as well as creating multiple reports embodying the data mining capabilities of the present invention.

When a purchaser buys one or more items or services at a store, hotel, automobile rental agency, or other service or goods provider (collectively, a “point of purchase”), the present invention creates a set of purchase transaction data detailing the purchase. The purchase transaction data is then transmitted to a database and stored as a data record.

Further, the present invention may accept a purchaser's identifying information, such as name, physical home address, telephone number, Social Security Number, and electronic mail address. Identifying information is generally stored in the database as an associated purchaser record by an embodiment of the present invention. A user may directly enter identifying information (for example, via a keyboard, touch pad, or other input device), the information may be entered at any time by the seller, or the information may be retrieved from previous transaction data for that purchaser. Generally, a “user” of the present invention refers to a store or point of purchase employee, rather than a purchaser.

The purchase transaction and purchaser data are generally transmitted from the point of purchase to a SQL database. The database may be located at the point of purchase or may be remotely accessed via a network by a computer or other network-accessible system located at the point of purchase. For example, a clothing boutique may maintain a dedicated server on the premises, or may access a server containing the database via the Internet. Further, the server may be operated and maintained by a third party.

A purchaser may receive the transaction data in the form of an electronic receipt, typically sent to the purchaser from the database via electronic mail (e-mail). The purchaser may then review and print the electronic receipt at his or her convenience. This permits both a purchaser and a seller to maintain a digital copy of any and all transactions made at points of purchase employing the present invention. This, in turn, minimizes paper files kept by all parties, ensures that receipts are never accidentally lost or mislaid, and provides an easy method for quickly obtaining a copy of a receipt whenever necessary. For example, many stores permit return of merchandise within thirty days with a receipt. The present invention allows a customer to quickly and easily locate a downloaded electronic receipt and print it out, thus simplifying the return process.

Further, the present invention permits a seller or other user of the invention to review data for an individual purchaser, class of purchaser, store, and so forth. This information may be used to create and analyze various types of reports. For example, sellers may track the purchasing habits of selected customers in order to better anticipate their needs and keep proper inventory levels at hand for such customers. Similarly, sellers may choose to send electronic coupons to customers who have spent more than a certain amount of money at the point of purchase, or target a specific demographic of purchasers with electronic or standard mail advertisements. Other examples of reports and data manipulation and mining are provided below.

### BRIEF DESCRIPTION OF THE FIGURES

FIG. 1 displays an exemplary operating environment for an embodiment of the present invention.

FIG. 2 displays an embodiment of the present invention.

FIG. 3 is a flowchart detailing the creation, storage, and transmission of an electronic receipt in accordance with an embodiment of the present invention.

FIG. 4 displays an electronic receipt in accordance with an embodiment of the present invention.

FIG. 5 displays a comma-delimited file detailing purchaser transactions in accordance with an embodiment of the present invention.

FIG. 6 displays a computer-generated HTML frame in accordance with an embodiment of the present invention FIG. 7 displays a computer-generated purchaser appreciation report in accordance with an embodiment of the present invention.

FIG. 8 displays a computer-generated summary report in accordance with an embodiment of the present invention.

FIG. 9 displays a computer-generated transaction report in accordance with an embodiment of the present invention.

FIG. 10 displays a computer-generated purchaser shopping frequency report in accordance with an embodiment of the present invention.

FIG. 11 displays a computer-generated purchaser spending report in accordance with an embodiment of the present invention.

FIG. 12 displays a computer-generated electronic coupon in accordance with an embodiment of the present invention.

### DETAILED DESCRIPTION

Generally, the present invention comprises a method and system for electronically creating, storing, and transmitting a receipt from a point of purchase or data storage to a customer. The invention further comprises a method and system for manipulating, viewing, and data mining a database containing one or more such electronic receipts.

When a purchaser buys one or more items or services at a store, hotel, automobile rental agency, or other service or goods provider (collectively, a “point of purchase”), the present invention logs the transaction and compiles a set of transaction data. The purchaser may be asked to supply identifying information, such as a name, physical home address, telephone number, and electronic mail address. This information is typically also stored in the associated purchase record by an embodiment of the present invention. The user may directly enter identifying information (for example, via a keyboard, touch pad, or other input device), the information may be entered at any time by the seller, or the information may be retrieved from previous transaction data for that purchaser.

The transaction data is usually transmitted from the point of purchase to a database, which in turn stores the record. The database may be located at the point of purchase or may be physically remote. For example, a multi-store business chain may have a single database accessed by each individual outlet in order to centralize data storage and minimize database cost.

A purchaser may retrieve the transaction data in the form of an electronic receipt, typically sent to the purchaser from the database via electronic mail (e-mail). The purchaser may then review and print the electronic receipt at their convenience. This permits both a purchaser and a seller to maintain a digital copy of any and all transactions made at points of purchase employing the present invention. This, in turn, minimizes paper files kept by all parties, ensures that receipts are never lost or mislaid, and provides an easy method for quickly obtaining a copy of a receipt when necessary. For example, many stores permit return of merchandise within thirty days with a receipt. The present invention allows a customer to quickly and easily locate the electronic receipt and print it out, thus simplifying the return process.

Further, the present invention permits a seller or other user of the invention to review data for an individual purchaser, class of purchaser, store, and so forth. This information may be used to create and analyze various types of reports. For example, sellers may track the purchasing habits of selected customers in order to better anticipate their needs and keep proper inventory levels at hand. Similarly, sellers may choose to send electronic coupons to customers who have spent more than a certain amount of money at the point of purchase. Other examples of reports and data manipulation and mining are provided below.

### Exemplary Operating Environment

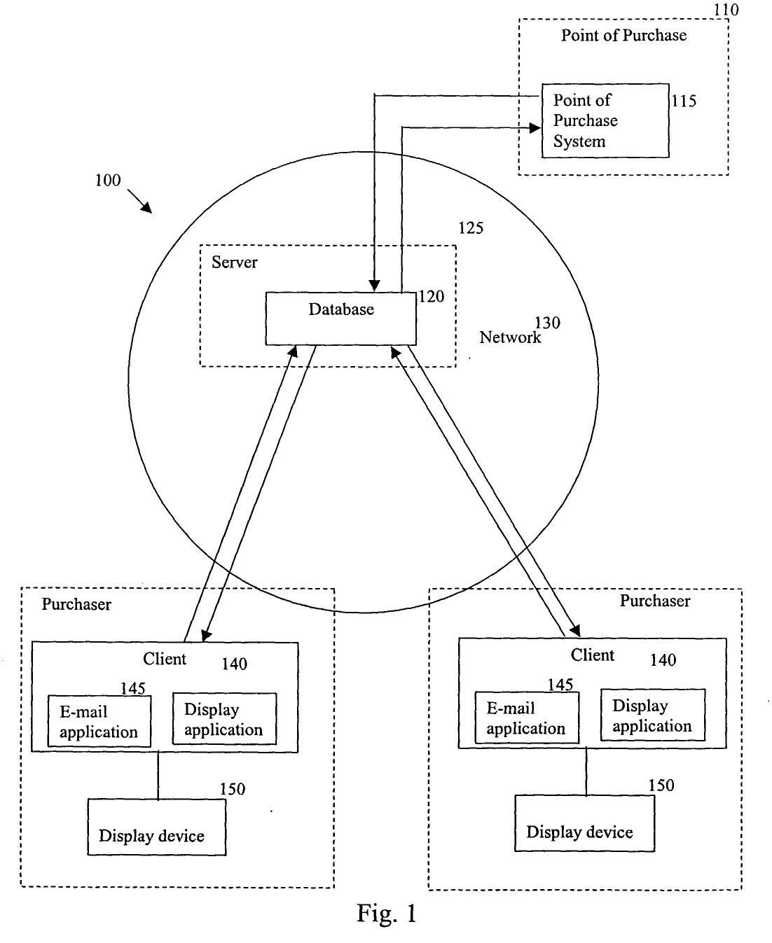

FIG. 1 and the following discussion are intended to provide a brief, general description of one suitable computing environment in which the invention may be implemented. While the invention will be described in the general context of an application program that runs on an operating system in conjunction with a personal computer, those skilled in the art will recognize that the invention may also be implemented in combination with other program modules. Generally, program modules include routines, programs, components (such as stacks or caches), data structures, and so forth, that perform particular tasks or implement particular abstract data sets.

Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communication network. In a distributed computing environment, program modules may be located in both local and remote memory storage devices.

FIG. 1 shows a functional block diagram illustrating the system architecture of an exemplary embodiment of the present invention, namely an electronic receipt generator 100. The present invention is shown in a client-server environment. The present invention generally consists of multiple data files or programs located and operating at separate locations, although alternate embodiments may employ a single program or application at a single location.

A point of purchase 110 gathers sales and identifying data for each purchase made by a customer. This data is collectively referred to as “transaction data,” and is entered into a point of purchase system 115. The transaction data may be captured manually (e.g., entered by the purchaser or a clerk), automatically, or through a combination of the two. For example, purchase information may be automatically gathered from a universal product code (UPC) scanner, and identifying data may be manually entered. Of course, identifying data may also be automatically gathered. As a further example, identifying data may be automatically captured from the magnetic strip on a purchaser's credit card.

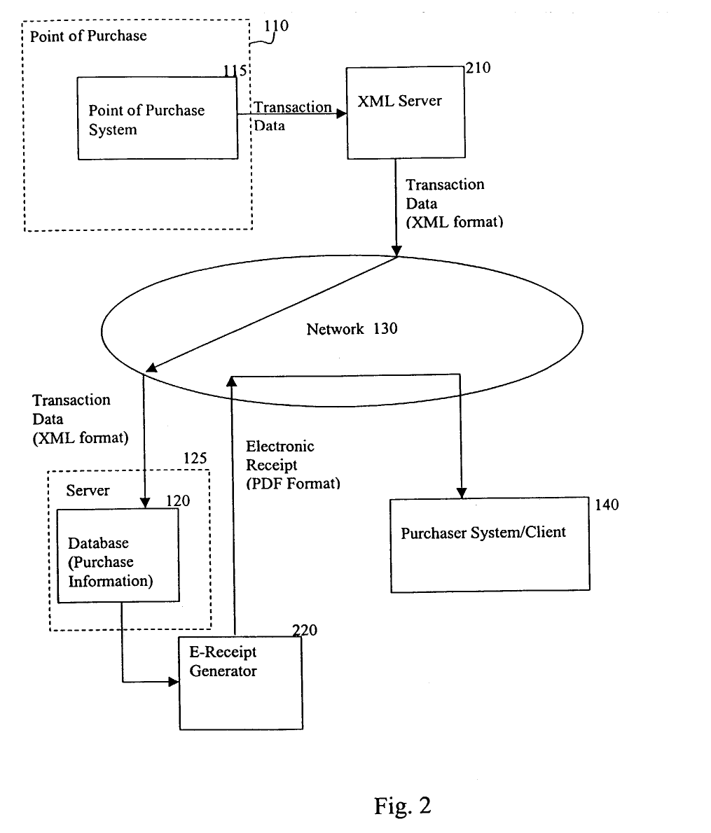

The transaction data is transmitted from the point of purchase 110 to a server 125 via a network 130. The network 130 may be a local area network (LAN), wide area network (WAN), Intranet, Internet, cable network, and so forth. The method of transmission may be any method known to those skilled in the art, including landline, microwave, radio, satellite, infrared, and other forms of wireless transmissions. Further, the transaction data may or may not be digitally compressed. The server 125 stores the transaction data as a record in a database 120. The operation of the database 120 is discussed below with reference to FIG. 2. In broad terms, the transaction data is stored as a record within the database 120 for later manipulation and review.

The database 120 may then compile the transaction data into a computer-readable file called an “electronic receipt.” In the present embodiment, the electronic receipt looks substantially similar to a typical, store-printed receipt. It displays the purchase information and some or all of the identifying data. In the present embodiment, the electronic receipt is generated as a portable document format (PDF) file. PDF files are widely recognized and are simple to view and print using most modern computers. The electronic receipt is then transmitted across the network 130 to a purchaser's client computer 140 by e-mail. The electronic receipt may comprise the body of the e-mail, or may be an attachment. The client 140 may be a mini-, micro-, or personal computer, a personal digital assistant (PDA), web tablet, cellular phone, or any other device capable of receiving and displaying e-mail messages.

The purchaser generally receives the e-mail and associated receipt via an e-mail application 145 resident on the client 140. In order to view the receipt, the purchaser typically uses a display application 147, such as one of the ACROBAT suite of programs manufactured by Adobe Systems, Inc. of San Jose, Calif. The display application 147 shows the electronic receipt on a display device 150 attached to the client 140. This display device is typically a computer monitor, but may also be a television, LCD screen, notebook monitor, printer, and so forth.

### Embodiment of the Present Invention

FIG. 2 displays an embodiment 100 of the present invention. First, a point of purchase system 115 is located within a point of purchase 110. The point of purchase system 115 gathers all sale and identifying data for each sale made to a customer. Sale and identifying data have already been discussed, above. Additionally, the point of purchase system 115 contains store and branch data sets. The store and branch data identify the parent company and local point of purchase, respectively. It should be noted that one or both of these data sets may be omitted, especially when the point of purchase is a single store not affiliated with any larger company or chain. Data sets and their related data subsets (generally referred to as “attributes”) are discussed more fully below.

The transaction, store, and branch data are converted into a transmission format and sent to a customer purchase database 120 via a network 130. In the present embodiment, the data is converted into extensible markup language (XML) format by an XML server 210. The XML server 210 may be located at the point of purchase 110 or may be physically remote from it. Further, the XML server 210 may be a portion of the point of purchase system 115 or may be an application, program, or data structure running thereon. Alternate embodiments may convert the transaction, store, and branch data to a different format, such as hypertext markup language (HTML), standard generalized markup language (SGML), document style semantics and specification language (DSSL), and so forth.

The database 120 logs the transmitted data as a database record. In the present embodiment, the database is a SQL server database and stores database records in tables. Generally, the SQL database 120 is a relational database permitting tables to be formed from any number of database records having one or more attributes (colloquially referred to as “fields”) in common. Accordingly, the database 120 is extremely flexible and permits the grouping of any given set of transaction data in multiple tables. For example, a set of transaction data may be placed in a first table containing all transaction data relating to a specific purchaser, in a second table containing all transaction data for a specific store, and a third table containing all transaction data relating to the type of item purchased. Alternate embodiments may employ different types of databases 120 other than SQL databases.

Once the transaction data is stored in the database 120, an electronic receipt is generated by an e-receipt generator 220. In the present embodiment, the e-receipt generator 220 converts the electronic receipt from a database record to a transmittable file format, such as the PDF format. The e-receipt generator 220 may be located at the system storing the database 120 or may be physically remote. Further, the e-receipt generator 220 may be a portion of the database 120 or may be an application, program or data structure running thereon. The electronic receipt is then transmitted across the network 130 to a purchaser's client computer 140, where it is received by an e-mail application 145 and available for viewing with a display application 147. Generally, the electronic receipt arrives in a file format tat may not be easily altered, such as the PDF file format. This prevents the customer from quickly altering any information contained in the receipt. The electronic receipt may be printed by a customer.

In the present embodiment, the point of purchase system 115 may be configured to transmit transaction data from the point of purchase 110 to the database 120 every six, twelve, or twenty-four hours, as desired. Similarly, the database 120 generally sends newly logged and created electronic receipts to a customer every six hours. Alternate embodiments may vary either or both of these timetables, or may be substantially real-time with respect to either or both transmissions.

Further, a store, company, or branch employing the present invention may access the database 120 in order to create a variety of tracking reports. These reports permit a user to extract data from the database 120 and present it in a variety of useful and informative formats. Several such reports are discussed below, in the section entitled “Database Reports.” Reports are generated from data stored in the database 120. Generally, each datum belongs to one or more data sets, as discussed in the following section.

### Data Sets

Generally, a data set defines a specific entity having a relationship to the present embodiment. Sample entities defined by a data set include a specific store processing a transaction, a purchaser, a chain or corporation to which a specific store belongs, and so forth. Each data set may be stored as one or more records in a database 120 and may be manipulated via various queries to form one or more reports. The present embodiment may store multiple examples of each data set. For example, a “store branch” data set defines a specific point of purchase 110 or branch of a larger, overall company, which in turn is represented by “store” data. For each store data set (e.g., “HERTZ”), multiple store branch data sets may exist and be related thereto (e.g., “Hertz office #217” and “Denver International Airport Hertz”).

Typically, each data set has one or more entries, or “attributes.” The attributes vary by data set. Data sets and attributes are used by the present invention to create electronic receipts and reports, as further detailed below. Although specific attributes are listed for each type of data, alternate embodiments may omit any or all of the below attributes or may add additional attributes without departing from the spirit or scope of the invention. Accordingly, these attributes are given by way of example and not limitation.

A first example of a data set is “store data.” Store data defines the point of purchase 110 or chain generally using an embodiment of the present invention. Store data typically includes four attributes: name, graphic, receipt text, and coupon text. The name attribute simply defines the name of the company, such as “Wal-Mart,” “SEARS,” or “AVIS.” The graphic stores a logo, trademark, or other identifying symbol for use with receipts or coupons generated by the present invention. The graphic may be stored in any of a number of file formats, such as joint photographic experts group (JPEG), bitmap, tagged information file (TIFF), graphics information file (GIF), portable network graphics (PNG), and other formats well known to those skilled in the art. The receipt text attribute allows the company to specify a piece of text that will appear on all receipts for all points of purchase 110 associated with the company. For example, Wal-Mart may wish every receipt for all of its stores to include the sentence, “Thanks for shopping at Wal-Mart!” at the bottom of the receipt. Finally, the coupon text attribute includes a text fragment to be printed on all electronic coupons generated by the present embodiment, much like the receipt text attribute just described. Generally speaking, each store defined by a set of store data includes one or more store branches.

A store branch is a specific point of purchase 110 affiliated with the entity defined by store data. Each store branch data set belongs to a store data set. For example, while Wal-Mart may be a store, “Wal-Mart #984” would comprise a store branch. Of course, a single store may serve as both the store entity and store branch entity, especially where the single store is a stand-alone location without affiliated points of purchase 110 or related companies.

In this embodiment, store branch data includes the following eight attributes: branch number, address line 1, address line 2, city, state code, zip code, phone number, and tax percentage. The branch number attribute contains the branch number or identification for the specific point of purchase generating transaction data. The address line 1 and address line 2 attributes together store the street address of the point of purchase, while the city, state, and zip attributes contain the city, state, and zip code for the specific point of purchase 110. The phone number attribute stores the contact telephone number for the specific point of purchase 110. Finally, the tax percentage attribute contains the total tax rate charged by the specific point of purchase on transactions. Alternate embodiments may include multiple tax percentage attributes (“tax percentage 1,” “tax percentage 2,” and so forth) for locales in which different tax rates apply to different goods.

The “Purchaser data” set is related to the purchaser buying a product or service at a particular point of purchase 110 or store branch. Purchaser data includes a single attribute, namely the purchaser's electronic mail address. The address is typically supplied by the purchaser to the store every time a transaction is conducted, or alternately may be retrieved from the database 120 if the purchaser is a repeat customer.

Each transaction performed by a purchaser generates purchaser transaction data. Every purchaser transaction data set belongs to a purchaser data set, and to a store branch data set. That is, each purchaser transaction is performed by a specific purchaser at a specific store branch. These relationships are stored in the database 120 as part of the purchaser transaction data set.

Generally, purchaser transaction data may include the following seven attributes: sale date, sale time, sale amount, transaction number, subtotal amount, tax amount, and method of payment. The sale date attribute stores the date on which a transaction is made in a store branch by a purchaser, while the sale time attribute stores the time of the transaction. The sale amount attribute stores the total dollar or monetary amount of the sale. The transaction number attribute contains a unique number generated by the store branch for the present transaction, that a user of the present embodiment may use to recall the purchaser transaction data for the specific transaction from the database 120. The subtotal amount attribute stores the pre-tax transaction total, and the tax amount attribute contains the total tax charged by the store branch. Finally, the method of payment attribute stores the type of payment made by the purchaser for the transaction. Examples of payment methods stored in this attribute include “cash,” “credit card,” “check,” and so forth.

Every transaction consists of, and is linked to, one or more transaction line items. Transaction line item data defines a single item purchased or returned during a transaction. For example, a purchaser may buy five items in a single transaction: a pair of shoes, a first shirt, a second shirt, a pair of pants, and a pair of socks. Each item (for example, the first shirt) comprises a transaction line item. Transaction line item data comprises five attributes: sequence number, item number, description, price, and category. The sequence number attribute stores a sequential number assigned to a given line item. Continuing the above example, the pair of shoes might be assigned sequence number one, the first shirt sequence number two, and so on. The item number generally stores a number or identification code (such as, but not limited to, a UPC code) assigned to the line item by a store or branch. Thus, the item number attribute may be viewed as an identifier used by the store or branch to classify the subject of the transaction.

Next, the description attribute stores a brief description of the thing that is the subject of the transaction line item. In the ongoing example, the description attribute might store “shoes,” “pants,” “shirt,” and so on. The description attribute may also store more detailed summaries, such as “Cole Haan loafers-black” in place of “shoes.” As with other attributes, the extent of the description attribute is generally set by a store or store branch. Finally, the price attribute contains the price paid for an item, and the category attribute stores a category to which the item belongs. Generally, categories are convenient ways to classify items of a specific type together in broad groups. For example, the category attribute might store “electronics” for stereos, televisions, and DVD players, or might store “clothing” for the items in the example given above.

The last data set implemented by the present invention is system data. System data defines information universal to all stores and purchasers, but configurable by a specific store. System data has a single attribute, the from e-mail address attribute. This attribute stores the electronic mail address shown as the “from” address on reports or electronic mail receipts generated by the system. Although the present embodiment uses a single set of system data, alternate embodiments may use multiple sets of system data. For example, an alternate embodiment may have one set of system data for each store or store branch, thus permitting a specific chain of stores to have a unique “from” electronic mail address. This allows the chain to personally field inquiries or respond to customer or purchaser comments, rather than relying on a single point of contact as in the present embodiment.

### Operation of the Embodiment

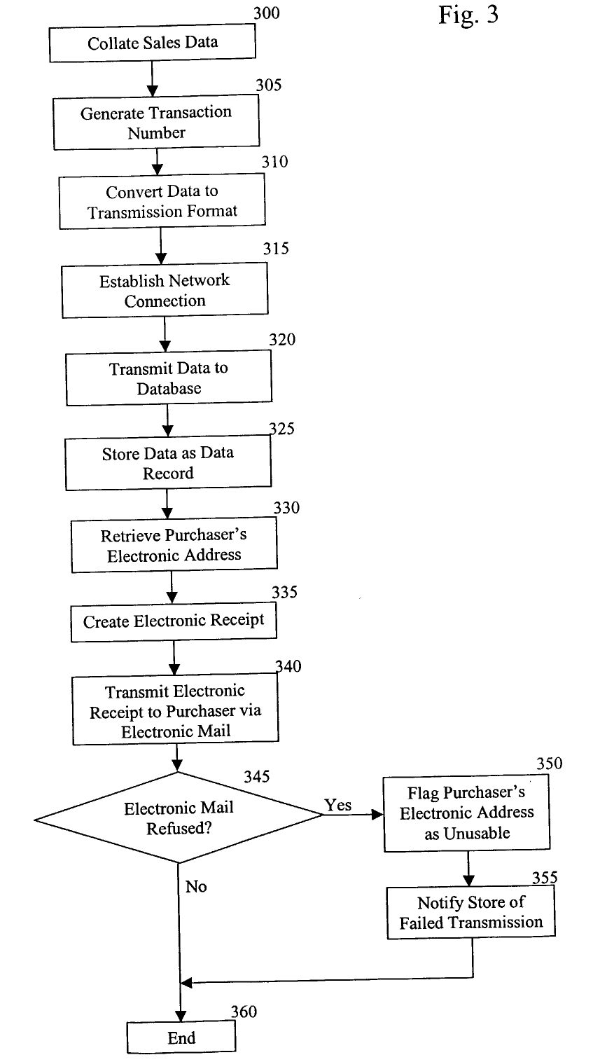

FIG. 3 is a flowchart detailing the creation, storage, and transmission of an electronic receipt in accordance with an embodiment of the present invention. Starting in step 300, the point of purchase 110 collates purchase information for a particular transaction. This data may include a purchaser transaction data set, transaction line item data set, store branch set, and a purchaser data set, as defined above.

In step 305, a unique transaction number is created to identify the transaction. It should be noted that, although the term “transaction number” is used throughout this document, any combination of letters, numbers, and symbols may be used when creating the transaction number. The transaction number is then added to the purchase information for transmission to a database 120.

Next, in step 310 the transaction number and purchase information are converted to a format suitable for transmission to the database. In the present embodiment, the data are formatted as an XML-compliant data set by an XML server 210.

In step 315, a connection from the point of purchase system 115 to the database 120 (or server) is established via the network 130. Where the database 120 is located on the same computer or system 115 as that operated by the point of purchase 110, this step may be omitted. After the connection is established, the purchase information, including the transaction number, is transmitted across the network to the database 120 in step 320. In step 325, the database stores the purchase information as one or more data records.

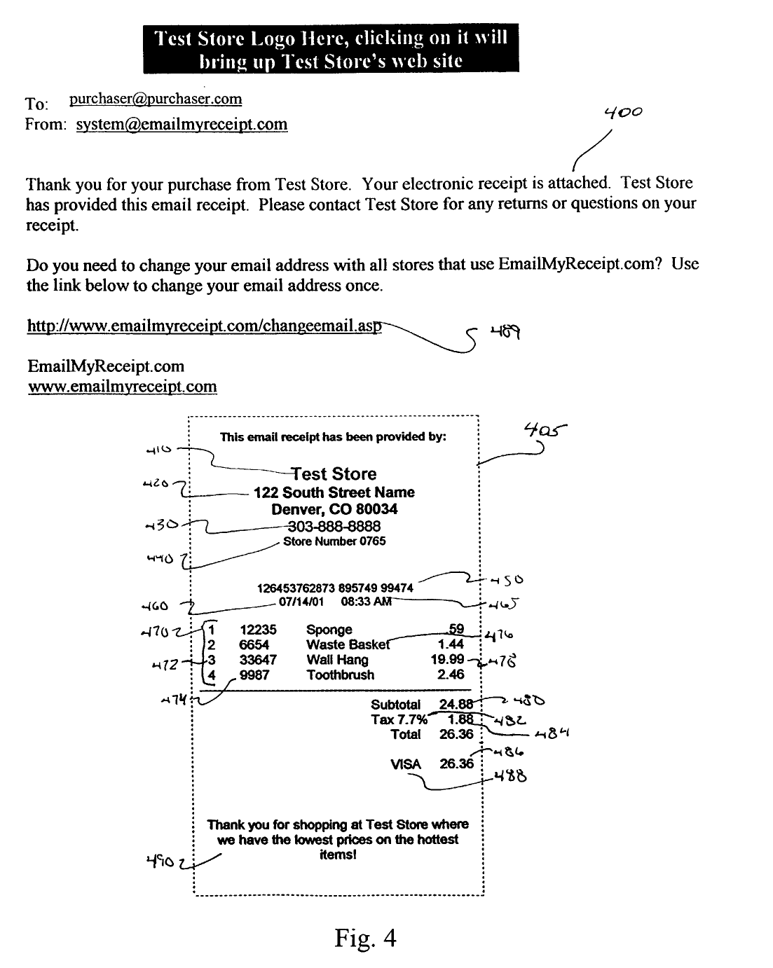

Steps 330-360 detail the creation and transmission of an electronic receipt from the data records in the database 120. In step 330, the embodiment retrieves the purchaser's electronic address from the database 120, where it is typically stored as the electronic mail attribute of the purchaser data set. In step 335, the embodiment creates an electronic receipt by importing various attributes from the database 120 and assembling them. A sample electronic receipt 405 is shown in FIG. 4, and the importation of attributes and assembly of the receipt is discussed in further detail with respect thereto.

In step 340, the electronic receipt is transmitted to the purchaser, across the network 130, via electronic mail. Generally, the electronic receipt 405 is embedded as an object in the electronic mail, although alternate embodiments may attach the receipt to the e-mail.

Of course, some purchasers may have changed their electronic mail address since they last registered with the present invention or otherwise provided their address to a point of purchase 110 employing the present invention. In such cases, the electronic mail may be refused and returned. In step 345, the embodiment checks for such a “bounced” e-mail. If the e-mail was not refused, the electronic receipt 405 was successfully delivered and the process terminates at end step 360. If, however, the electronic mail was refused, the embodiment executes step 350 and flags the purchaser's electronic address stored in the database 120 as unusable. In alternate embodiments, the purchaser's electronic address may be tried one or more additional times to check whether such bounces are caused by temporary network conditions prior to flagging the address as unusable.

Next, in step 355, the embodiment notifies the store 110 of the failed transmission, so that the store may contact the purchaser by more conventional means or provide an updated e-mail address for the purchaser. Finally, the process ends at step 360.

### Electronic Receipt Generation

FIG. 4 displays a sample electronic mail message 410 and electronic receipt 405 generated by the present invention. The electronic receipt 405 is automatically created by the embodiment and electronically mailed to the purchaser every time a transaction is completed and stored as a record in the database.

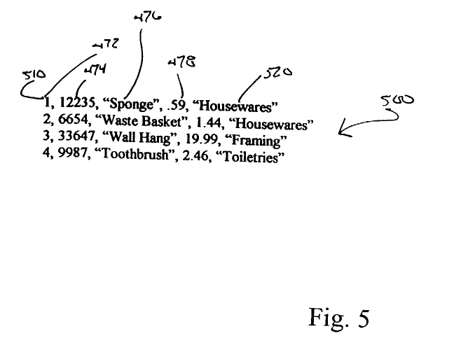

Generally, the electronic receipt 405 is transmitted via an HTML-formatted electronic mail 400. The receipt itself may be HTML formatted, .PDF formatted, or may employ any other format that does not permit a purchaser to easily alter the receipt details. The electronic receipt 405 may be embedded as a viewable object in the electronic mail, or may be attached thereto. Also attached to the electronic mail is a comma-delimited file 500, shown in FIG. 5. The comma-delimited file 500 contains the same information that appears on the electronic receipt 405, but in a different format.

Returning to FIG. 4, the electronic receipt 405 displays the name 410, address 420, phone number 430, and branch number 440 of the point of purchase 110 at which the associated transaction occurred. Generally, each electronic receipt also includes a transaction number 450 identifying the specific transaction detailed in the receipt, along with the date 460 and time 465 of the transaction. This information is retrieved from the various attributes comprising records in the database.

Similarly, the receipt may contain multiple item lines 470, each of which details a specific item involved in the associated transaction. Each item line displays an item line number 472, an item number 474, an item name 476, and a subtotal amount 478. For example, in the electronic receipt shown in FIG. 4, there are four item lines. The first item line 470 shows “1” as the item line number 472, “12235” as the item number 474, “Sponge” as the item name 476, and “0.59” as the subtotal amount 478. Generally speaking, each of the above elements of the item line 470 correspond to attributes of the purchaser transaction data set associated with the transaction shown on the receipt. Accordingly, the embodiment may simply retrieve attributes from the database as necessary to generate item lines for the electronic receipt 405.

Also included on the electronic receipt 405 are a subtotal amount 480 for all items involved in the transaction, a tax rate 482, a tax amount 484, a transaction total 486, and a method of payment 488. Values for each of these elements are retrieved by the embodiment from the attributes in the transaction data set having the same name, with the exception of the transaction total. The transaction total 486 is calculated by adding the subtotal amount 480 to the tax amount 484.

The electronic receipt 405 may also include an option permitting a purchaser to change his or her electronic mail address. In the present embodiment, this option takes the form of a hyperlink 489. The hyperlink 489, when clicked, may either open a new Web page with instructions for changing the purchaser's e-mail address. Alternately, clicking the hyperlink 489 may create an e-mail from the purchaser's e-mail application 145 directed to the database 120 or server 125. In this case, the e-mail will contain the new address. In either embodiment, the database 120 may receive the new address and update the purchaser electronic address attribute.

Optionally, the electronic receipt 405 may also include a message to the purchaser, shown in FIG. 4 as a receipt text field 490 at the bottom of the receipt. The text placed in the receipt text field by the embodiment is taken from the receipt text attribute stored in the database, which is part of the store data set.

In addition to enclosing the electronic receipt in an HTML-formatted e-mail, the comma-delimited file 500 is appended or attached to the e-mail 410 for importation into financial software applications. The comma-delimited file 500 is shown in FIG. 5. Each line 510 of the comma-delimited file 500 contains the same elements as the corresponding item line of the electronic receipt, namely item line number 472, an item number 474, an item name 476, and a subtotal amount 478. These elements have the same values as shown in the electronic receipt 405, and are retrieved from the same attributes stored in the database. Each line 510 may also include a category identifier 520, indicating to what category the purchased item belongs. Each element is separated from the next by a comma. The comma-delimited file 500 may be quickly and easily imported into many commonly-used financial applications, such as the Money application, created and marketed by Microsoft Corp. of Redmond, Wash., or the QUICKEN application, created and marketed by Intuit, Inc. of Mountain View, Calif. This permits purchasers to keep track of transactions in an efficient manner.

### Report Generation

The present invention may also generate a variety of reports on request from records stored in the database 120. Reports may detail a variety of information, such as transaction frequency for a specific purchaser, total sales for a store or store branch during a specified time period, sales by category for a store or branch, and so forth.

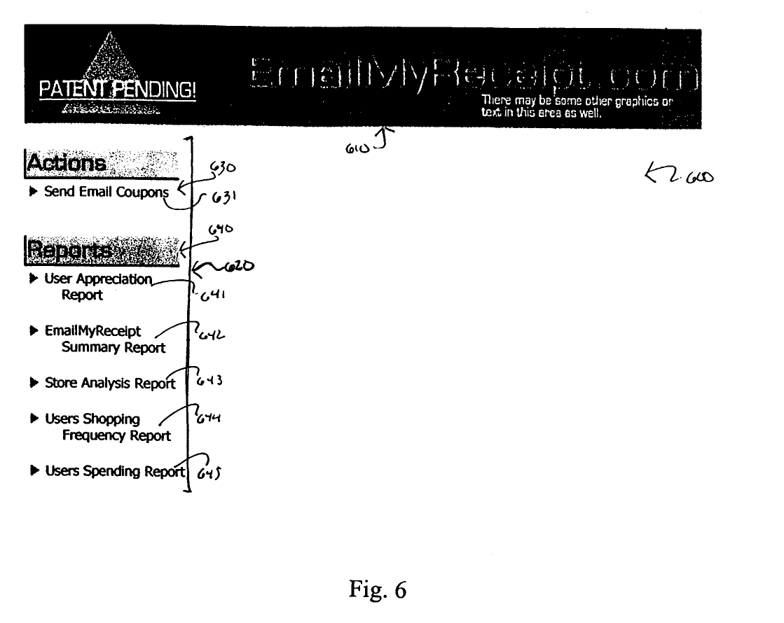

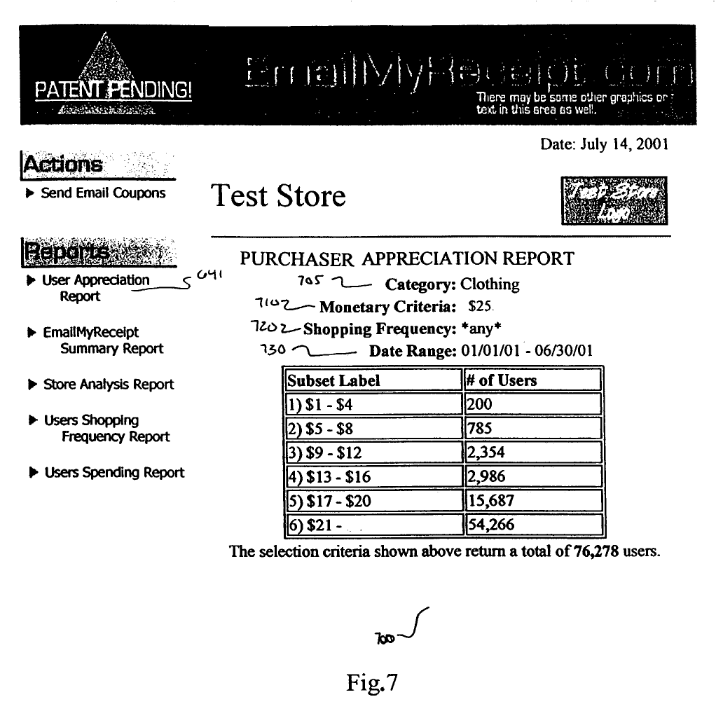

A user may generate a report by accessing a server or website operably connected to the database 120 and requesting the desired report. Generally, this access is accomplished by establishing a connection across the network 130 (FIG. 1) between a local computer 200 and the server. In the present embodiment, the server displays an HTML-formatted Web page 600 to the user, as shown in FIG. 6. This Web page includes a header 610 displaying the website name (here, “EmailMyReceipt.com”) along with a website graphic. Further, the website contains a sidebar 620 having two subsections, namely an “Actions” area 630 and a “Reports” area 640. Both the Actions area 630 and the Reports area 640 contain hyperlinks 631, 641, 642, 643, 644, 645. A user may click on or otherwise access (collectively, “click”) any of these hyperlinks to create different types of reports.

One example of a report is the purchaser appreciation report 700, shown in FIG. 7. Generally speaking, this report displays the number of purchasers who have bought goods or services from the store costing a specified amount within a specified timeframe.

By clicking on the purchaser appreciation report hyperlink 641, the user may access a purchaser appreciation report creation form (not shown). This form be presented as a separate Web page, a Web page displayed in an internal frame on the main Web page 600, a pop-up box, and so forth. In this embodiment, the user may specify four input criteria in the purchaser appreciation report creation form in order to create a purchaser appreciation report, namely category, monetary criteria, shopping frequency, and date range. These choices may be manually inputted, or may be selected from one or more drop-down boxes on the form.

FIG. 7 displays a sample purchaser appreciation report 700 generated in response to a user's input. Here, the user has chosen the category 705 “clothing,” monetary criteria 710 of less than $25, any shopping frequency 720, and a date range 730 from Jan. 1, 2001 to Jun. 30, 2001. These criteria indicate what data the system must retrieve from the database 120 in order to generate the purchaser appreciation report. Typically, the system will retrieve all purchaser transaction data sets corresponding to a purchaser transaction line item data set having a category attribute matching the specified value. In the example shown in FIG. 7, only purchaser transaction data sets linked to line items in the clothing category would be retrieved.

Next, the system reviews each purchaser transaction data set to determine whether the cost of the transaction satisfies the inputted monetary criteria. If not, the data set is discarded. When specifying monetary criteria, a user may select either a “less than” or “greater than” symbol (i.e., “<” or “>”) and a monetary amount. The combination of the symbol and monetary amount determines the maximum or minimum cost for any purchaser transaction to be included in the purchaser appreciation report. For example, the report shown in FIG. 7 collates and displays only those purchaser transactions with a cost less than or equal to $25. It should be noted in passing that transactions with a value exactly equal to the monetary amount are included in the purchaser appreciation report.

The next criterion is the shopping frequency criterion. In the present embodiment, the shopping frequency may be selected from a static list of possible frequencies. Broadly defined, the shopping frequency indicates how often a purchaser participated in a transaction for the given store. Possible shopping frequencies include once a week, once a month, once every six months, once a year, and “any.” The “any” shopping frequency effectively instructs the system that all data sets matching the other criteria are to be included in the purchaser appreciation report. The embodiment determines a purchaser's shopping frequency by retrieving all purchaser transaction data sets for the purchaser within the longer of the past year or since the system was activated, and dividing the number of records by the number of weeks in the longer timeframe. Continuing with the example shown in FIG. 7, the user has selected the “any” shopping frequency criterion.

A user may also specify a date range criterion to further limit the purchaser appreciation report output. Generally speaking, a user may select any starting and ending dates to create the date range criterion. Only those purchaser transaction data sets having a sale date attribute within the time frame specified in the date range criterion are included in the displayed report. As shown in FIG. 7, the date range desired by the user is from Jan. 1, 2001 to Jun. 30, 2001. Accordingly, only transactions taking place within this timeframe are collected and displayed.

As is also shown in FIG. 7, the system splits the monetary criteria range given by the user as equally as possible into six subranges, here shown as “subset labels.” Each subset label will always begin and end with a whole dollar amount, even if this requires rounding to the nearest dollar. Similarly, in order to group each purchaser transaction data set into a subset label, the sale price attribute of the purchaser transaction data set is also rounded to the nearest dollar. Where the monetary criterion is a “less than” criterion, the floor for determining the range of each subset label is always zero, and the ceiling is the user-specified dollar amount. Where the monetary criterion is a “greater than” criterion, the floor for determining each subset label is the user-specified dollar amount, and the ceiling is the highest sale amount attribute found in any purchaser transaction data set matching all other specified criteria.

The purchaser appreciation report displays the number of unique purchasers who have participated in a transaction falling within each subset label range. This information is typically presented as a subset table, but may be formatted differently in alternate embodiments. The purchaser appreciation report also displays the total of all purchasers in each subset label, as shown in the total line below the subset table.

Although the present embodiment generates purchaser appreciation reports on a store basis, alternate embodiments may create purchaser appreciation reports on a branch basis. This may permit a store or branch to track activity within a single branch, rather than on a company-wide basis. Further, alternate embodiments may permit a user to request such a report for all purchaser transaction line item data sets matching specified criteria, rather than limiting the report to purchaser transaction data sets. That is, an alternate embodiment may break down purchasers by purchases of individual line items, rather than overall totals for all items purchased in a single transaction or sale. This may be useful when reviewing records in the database 120 to determine purchasers who buy “big ticket” items, rather than screening purchasers who buy many lesser-priced items.

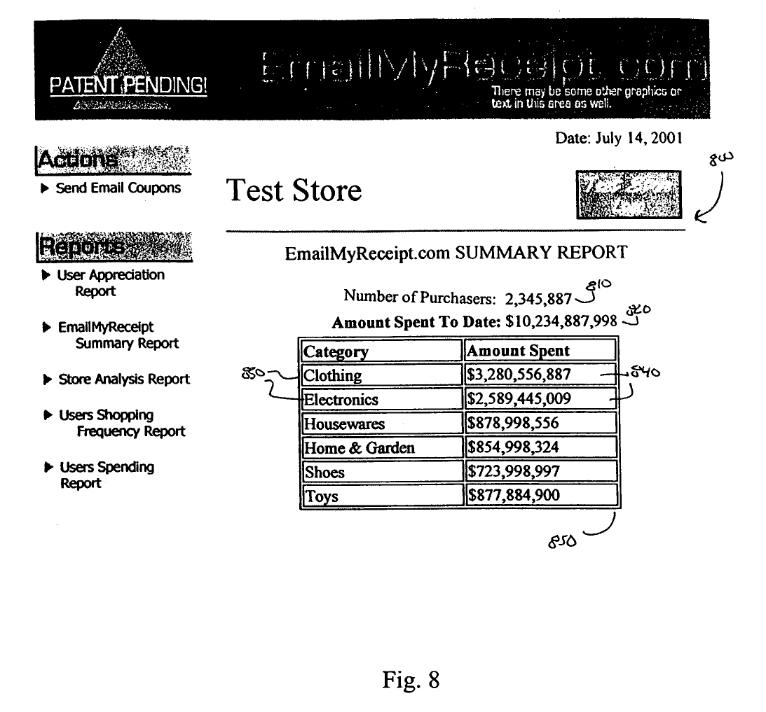

FIG. 8 displays a sample summary report 800. The summary report 800 is designed to provide a general overview of the number of purchasers shopping at a particular store or branch, as well as an aggregate amount of money spent at the store in various categories of goods or services. As with the other reports discussed in this section, the present embodiment displays the summary report in a frame bounded by the header 610 and sidebar 620 described with respect to FIG. 6. Unlike the purchaser appreciation report of FIG. 7, a user desiring to view a summary report selects no input criteria.

When the summary report 800 is generated, the embodiment determines the number of unique purchasers who have transacted business at the store or branch in question by reviewing all purchaser transaction data sets linked to the store or branch in question and then compiling the number of unique purchasers associated with those purchaser transaction data sets. This number is then displayed in the “number of purchasers” field 810 on the summary report 800.

Next, the embodiment adds together all subtotal amount attributes for each purchaser transaction data set associated with the store in question. This amount reflects the total sales for the store since the embodiment began operation, and is displayed in the “amount spent to date” field 820.

Finally, the embodiment determines total sales per category for the store or branch by reviewing all purchaser transaction line item data sets associated with the store, sorting the transaction line item data sets by their category attribute, and adding all price attributes for each sorted group of transaction line item data sets to arrive at a category total. Each category is displayed in a “category” field 830 of the summary table 850, while the corresponding category total is displayed in the “amount spent” field 840.

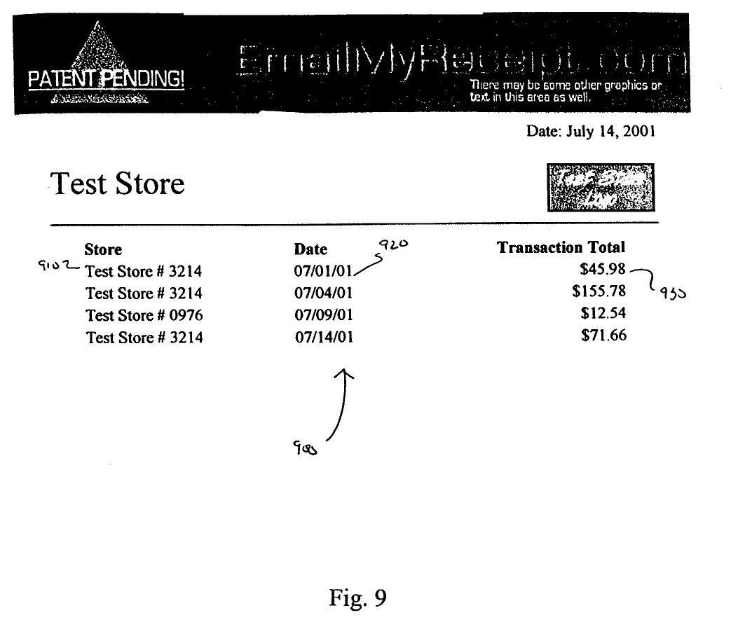

FIG. 9 displays a sample transaction report 900. The transaction report permits a user to view all transactions performed at a specific store for a selected period of time. In the present embodiment, the last ninety days' of transactions for all branches affiliated with a store may be viewed. Alternate embodiments may use different time periods, or may permit a user to specify a time period.

First, the embodiment determines all store branches associated with a particular store. Next, the embodiment retrieves from the database 120 all purchaser transaction data sets associated with any of the store branches. From each purchaser transaction data set, the embodiment retrieves the date and subtotal attributes. The embodiment displays the store branch attribute for each transaction in the “store” field 910, the date of the transaction in the “date” field 920, and the transaction subtotal in the “subtotal” field 930.

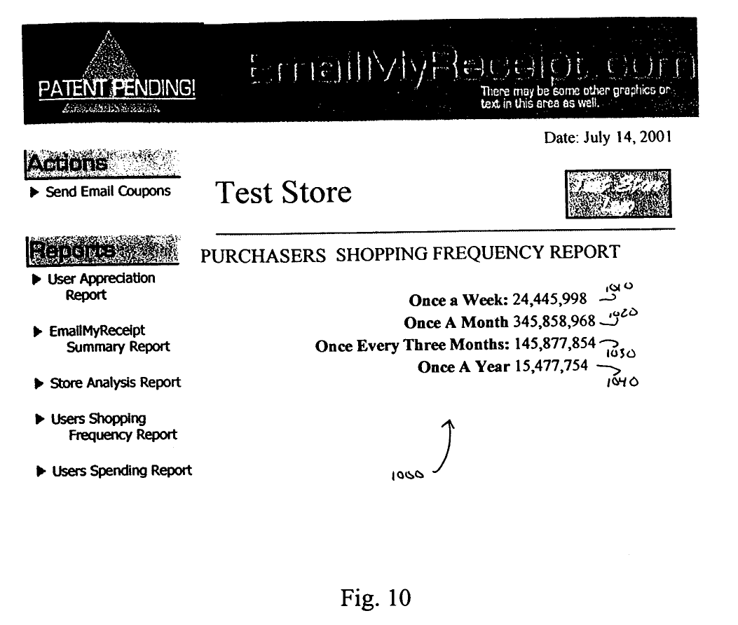

FIG. 10 displays a sample purchaser shopping frequency report 1000. The purchaser shopping frequency report 1000 provides an overview of how often purchasers complete transactions at a given store or branch. When selecting the purchaser shopping frequency report, a user does not specify any input criteria.

Generally, the embodiment determines which purchasers have shopped at the store or branch in question by querying the database 120. The database returns not only each purchaser for the store, but also the number of transaction data sets for each purchaser. The embodiment may then divide the number of transaction data sets by the number of weeks, months, three month periods, and years of the embodiment's operation to arrive at a weekly frequency, monthly frequency, three-month frequency, and yearly frequency, respectively. If a purchaser falls into a higher frequency category, he or she is removed from all lower frequency categories. For example, if a purchaser shops an average of once a month at the store or branch in question, he or she is not included in the “once every three months” and “once a year” categories. The frequencies are then displayed in the appropriate fields 1010, 1020, 1030, 1040.

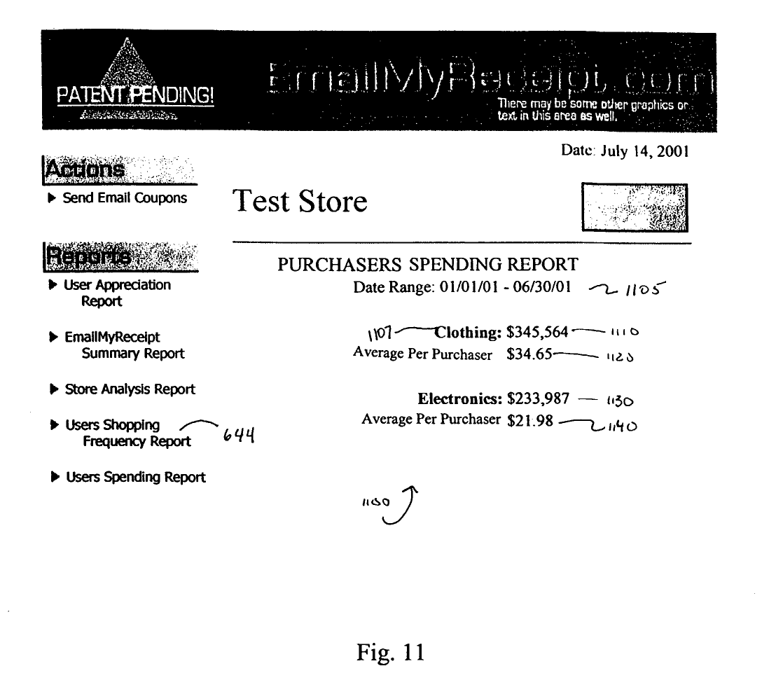

FIG. 11 displays a sample purchaser spending report 1100. Generally, the purchaser spending report 1100 shows the amount of money spent by all purchasers in one or more categories within a specific time frame, as well as the average purchase price per transaction. Initially, a user may select the spending report 1100 by clicking the “shopping frequency report” hyperlink 644. In response, the embodiment prompts the user to specify a date range and one or more categories to be analyzed in the report. As with the purchaser appreciation report 700, the user may enter these input criteria by any manner known to those skilled in the art.

The system retrieves all transaction line item data sets linked to a transaction data set having a sale date occurring within the specified time frame. For each such retrieved transaction line item data set, the embodiment determines whether the category attribute matches one of the specified categories. The price attributes from all transaction line item data sets having a category matching the user-specified category are then totaled, resulting in a category aggregate price. Finally, this total is divided by the number of purchaser transaction data sets associated with the totaled transaction line item data sets to yield an average price for all purchases in that category. This process is performed for each category specified by the user.

The user's chosen date range is displayed in the date range field 1105, while the category name is shown in the category field 1107. The category aggregate price is shown in the category total field 1110, 1130, and the average purchase price of all purchasers is shown in the “average per purchaser” field 1120, 1140.

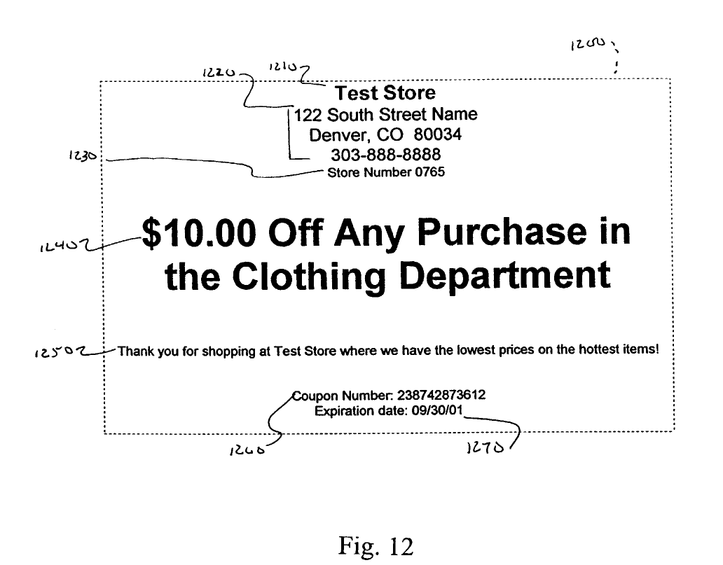

FIG. 12 displays a sample electronic coupon 1200. Users may instruct the embodiment to send coupons to valued purchasers in order to encourage repeat business. In one embodiment, the present invention may automatically generate coupons according to specific criteria, such as the frequency of a purchaser's transactions or the amount of a purchaser's transactions. For example, an electronic coupon 1200 may be sent to all purchasers who initiate a transaction at a point of purchase 110 at least twice a month, or to all purchasers who complete a transaction with a total price of $100 or more. In an alternate embodiment, a user may specify criteria for coupon generation. Typically, the embodiment automatically sends an electronic mail to all purchasers meeting the criteria with the coupon embedded as an object or attached thereto.

Generally, the electronic coupon 1200 displays a point of purchase name 1210, a point of purchase address 1220, and a point of purchase store number 1230. These identify the point of purchase 110 issuing the coupon 1200. The electronic coupon 1200 also shows coupon text 1240, which details the discount or other benefit available when the coupon is redeemed. The coupon may also display store text 1250, which is retrieved from the coupon text attribute of the store data set. Finally, each coupon is typically assigned a unique coupon number 1260 generated by the system, along with an expiration date 1270 past which the coupon is no longer valid.

### Purchaser Functionality

In addition to receiving electronic receipts automatically created and mailed by the embodiment, a purchaser may also access the database 120 in order to request additional copies of old receipts. In one embodiment, a purchaser may identify himself by providing purchaser-specific information, such as the combination of an electronic mail address on file with the database 120 and the amount of the last transaction shown on an electronic receipt 405. Other embodiments may use different identifying information, or may permit a properly authenticated purchaser to create a unique password, login identity, or both.

Further, a purchaser may access the database 120 to run reports similar to those detailed above. For example, a purchaser may query the database 120 to determine the total of all transactions logged by the present invention. As a further example, the purchaser may create a report showing all purchases at a specific store or branch, in a specific category, during a specific date range, within a specific dollar range or any combination of these criteria.

### Receipt Verification

Generally, when an electronic receipt is used by a purchaser to return one or more transaction line items, the receipt must be verified to ensure that it is authentic, and properly lists the items purchased at the point of purchase. The present invention permits a clerk, manager, or other person (collectively, “clerk”) associated with the point of purchase to verify the electronic receipt in a variety of ways.

In one embodiment, the clerk may verify the electronic receipt by inputting the transaction number 450 into a terminal, computer, or other point of purchase system 115. The transaction number is transmitted via the network 130 to the database 120. The embodiment then retrieves the data record corresponding to the transaction number 450 from the database and displays it on the point of purchase system 115 for the clerk's review. The clerk may then compare the record to the electronic receipt 405 tendered by the purchaser.

In another embodiment, rather than displaying a matching record for the clerk's review, the invention may simply inform the clerk that a record has been found in the database 120 matching the transaction number 450 on the electronic receipt 405. As the clerk inputs information pertaining to the return or exchange of a transaction line item, the invention may verify the inputted information against the record to ensure that each returned transaction line item was part of the original transaction.

In yet other embodiments, alternate data may be used to authenticate an electronic receipt 405. For example, an item number 474 or combination of a date 460 and time 465 of transaction may be used to retrieve or electronically verify an electronic receipt 405.

### CONCLUSION

As will be recognized by those skilled in the art from the foregoing description of example embodiments of the invention, numerous variations on the described embodiments may be made without departing from the spirit and scope of the invention. For example, a different database structure may be used, user reports may be easily and quickly created in multiple formats not listed herein, or additional information may be included in the electronic receipt. Further, while the present invention has been described in the context of specific embodiments and processes, such descriptions are by way of example and not limitation. Accordingly, the proper scope of the present invention is specified by the following claims and not by the preceding examples.

What is claimed is:

1. A method for generating an electronic mail receipt, comprising:
receiving a first set of purchase information concerning a first item purchased by a purchaser, the first set of purchase information including identifying information for the first item, price paid for the first item, and category information for the first item;
accepting a first set of store data comprising a store identifier associated with a first store;
storing the first set of purchase information and the store data in a database; and
generating an electronic mail receipt detailing at least a portion of the first set of purchase information and at least a portion of the first set of store data.

2. The method of claim 1, further comprising the step of transmitting the electronic mail receipt across a network to a purchaser's electronic mail address.

3. The method of claim 2, wherein the electronic mail receipt is transmitted as an attachment to an electronic mail message.

4. The method of claim 3, wherein the electronic mail message comprises:
an HTML-formatted portion containing the electronic receipt as an embedded object; and
a comma delimited file comprising:
an item line number;
an item number;
an item name;
an item subtotal; and
an item category.

5. The method of claim 4, wherein the embedded object comprises:
a store name;
a store address;
a store phone number;
a store branch number;
a transaction number;
a date of transaction;
a time of transaction;
a subtotal;
a tax percentage;
a tax amount;
a total sale number; and
a method of payment.

6. The method of claim 2, further comprising the steps of:
receiving an electronic mail address corresponding to the purchaser; and
storing the purchaser's electronic mail address in the database.

7. The method of claim 6, further comprising:
creating in the database a record comprising the first set of purchase information;
receiving a second set of purchase information concerning a second item purchased by the purchaser, the second set of purchase information including identifying information for the second item, price paid for the second item, and category information for the second item;
appending the second set of purchase information to the record; and
updating a sales total for the purchaser, the sales total comprising the total of all prices paid.

8. The method of claim 7, wherein the purchase information comprises:
a purchaser transaction data set; and
a transaction line item data set.

9. The method of claim 8, wherein the purchaser transaction data set comprises:
a sale date;
a sale time;
a sale amount;
a transaction number;
a subtotal amount;
a tax amount; and
a method of payment.

10. The method of claim 9, wherein the transaction line item data set comprises:
a sequence number;
an item number;
an item description;
an item price; and
an item category.

11. The method of claim 10, further comprising linking the transaction line item data set to the purchaser transaction data set in the database.

12. The method of claim 2, further comprising:
receiving a second set of purchase information concerning a second item purchased by a purchaser, the second set of purchase information including identifying information for the second item, price paid for the second item, and category information for the second item;
accepting a second set of store data comprising a store identifier associated with a second store;
storing the second set of purchase information and the second set of store data in a database; and
generating an electronic mail receipt for transmission to the purchaser, the electronic mail receipt detailing at least a portion of the second set of purchase information and at least a portion of the second set of store data.

13. The method of claim 2, wherein the steps of generating an electronic mail receipt comprising the item, price, and store data and transmitting the electronic mail receipt automatically occur in response to receiving purchase information from a point of purchase.

14. The method of claim 2, wherein the step of transmitting the electronic mail receipt occurs every six hours.

15. A business method for generating and transmitting electronic mail receipts, comprising:
receiving at least one set of purchase information concerning a first item purchased by a purchaser;
storing the at least one of set of purchase information as a first record in a database;
in response to a predetermined signal, generating an electronic mail receipt for the at least one of set of purchase information; and
generating a business report partially based on the at least one of set of purchase information.

16. The method of claim 15, wherein the at least one of set of purchase information is chosen from the group comprising:
a store data set;
a purchaser data set;
a transaction data set; and
a transaction line item data set.

17. The method of claim 16, wherein the business report comprises a summary report comprising:
a total of purchasers shopping at the store;
a total of purchase prices from the store; and
a breakdown of purchase prices by category of goods.

18. The method of claim 16, wherein the business report comprises a purchaser spending report comprising:
a breakdown of purchase prices by category of goods; and
an average purchase price per purchaser per category of goods.

19. The method of claim 16, wherein the business report comprises a transaction report comprising:
a total of purchase prices per purchaser per store; and
a date on which each purchase was made.

20. An electronic mail receipt generated for a purchaser, comprising:
an electronic mail address corresponding to the purchaser;
a purchaser transaction field;
a purchaser transaction line item;
a store identifier; and
wherein the electronic receipt is arranged according to a transmission format.

21. The electronic mail receipt of claim 20, wherein the transmission format comprises a PDF format.

22. The electronic mail receipt of claim 20 wherein the purchaser transaction field comprises:
a sale date;
a sale time;
a sale amount;
a transaction number;
a subtotal amount;
a tax amount; and
a method of payment.

23. An electronic coupon for redemption at a point of purchase, comprising:
a point of purchase name;
a point of purchase address;
a point of purchase store number;
coupon text detailing a coupon benefit;
a unique coupon number; and
an expiration date.

24. The electronic coupon of claim 23, wherein the electronic coupon is generated in response to criteria specified by a user.

25. The electronic coupon of claim 23, wherein the electronic coupon is generated in response to predetermined criteria.

26. The electronic coupon of claims 24 and 25, wherein the electronic coupon is electronically transmitted to an electronic mail address associated with at least one purchaser satisfying the criteria.
